(19) United States
(12) Patent Application Publication
(10) Pub. No.: US 2007/0110172 A1
(43) Pub. Date: May 17, 2007

(54) Channel estimation for ofdm systems

(75) Inventors: Michael Faulkner, Victoria (AU); Igor Tolochko, Victoria (AU)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: AUSTRALIAN TELECOMMUNICATIONS COOPERATIVE RESEARCH, Bentley, W.A. (AU)

(21) Appl. No.: 10/581,488

(22) PCT Filed: Dec. 3, 2004
(86) PCT No.: PCT/AU04/01704

§ 371 Date: Jan. 10, 2007

(30) Foreign Application Priority Data
Dec. 3, 2003 (AU) 2003906690

(51) Int. Cl. H04K 1/10; H04L 27/06

(52) U.S. Cl. 375/260; 375/340

(57) ABSTRACT

A method for performing channel estimation in an orthogonal frequency-division multiplexing system, the method including the steps of: receiving (80) transmitting pilot symbols from a plurality of transmit antennas; forming (82) a least-squares estimation matrix from the transmitted pilot symbols; forming (8488) a sparse smoothing matrix approximating a fixed weighting matrix, wherein each row vector in the sparse smoothing matrix contains one or more of the strongest weights in each row of the fixed weighting matrix; and (90) deriving a channel estimation matrix from the sparse smoothing matrix and the least-squares estimation matrix.

The present invention relates generally to methods of channel estimation in wireless Orthogonal Frequency Division Multiplexing (OFDM) systems, and in particular to methods of channel estimation using Linear Minimum Means Square Error (LMMSE) estimation techniques.

Orthogonal Frequency Division Multiplexing (OFDM) is a high spectral efficiency type of multi-carrier modulation system, which has many advantages of single carrier systems, especially for high data rate transmission in time dispersive channels. Transmitted diversity is an effective method to further improve wireless communication systems in fading environments. Space-time coded OFDM systems with transmitter diversity capable of reliable high data rate wireless communications promise to be an effective alternative for broadband wireless services. However, space-time coded systems require accurate estimation of channel frequency responses.

Traditional one-dimensional channel estimation techniques for OFDM systems include (a) Leased Squares (LS), (b) Minimum Means Square Error (MMSE) and (c) Linear Minimum Means Squared Error (LMMSE) estimation techniques. LS estimators have low complexity, but suffer from a high Means Square Error (MSE), especially if the system operates with low signal to noise ratios. On the other hand, MMSE estimators, based on time-domain channel statistics, are highly complex and require significant numbers of multipliers and adders in any practical implementation. MMSE estimators provide good performance for sample spaced channel environments, but have limited performance for non-sample spaced channels and high signal to noise ratios.

LMMSE estimators provide good performance for sample spaced and non-sample spaced channels. Nevertheless, practical implementations of LMMSE estimators suffer from being highly complex and require a large number of computations to be performed in order to achieve accurate channel estimation.

It would be desirable to provide a method for performing channel estimation in an OFDM system with transmitter diversity that is simple and efficient, and minimises the computational complexity of existing channel estimation techniques.

It would also be desirable to provide a method for performing channel estimation that alleviates or overcomes one or more problems of known channel estimation techniques.

One aspect of the present invention provides a method for performing linear channel estimation in an orthogonal frequency-division multiplexing system, the method including the steps of:

receiving transmitted pilot symbols from a plurality of transmit antennas;

forming a least-squares estimation matrix from the transmitted pilot symbols;

forming a sparse smoothing matrix approximating a fixed weighting matrix, wherein each row vector in the sparse smoothing matrix contains one or more of the strongest weights in each row of the fixed weighting matrix; and

deriving a channel estimation matrix from the sparse smoothing matrix and the least-squares estimation matrix.

In one embodiment the sparse smoothing matrix is defined according to:

$${E}_{j} ( k ) = {arg max}_{{w}_{j} ( k , m )} \{ ( {\sum }_{m = 0}^{M - 1} {\vert {w}_{j} ( k , m ) \vert}^{2} ) \vert {W}_{j} ( k ) \}$$

where Eⱼ(k) is the row energy of the sparse smoothing matrix with non-zero terms wⱼ(k,m) formed from the M strongest weights of the k'th row of the fixed weighting matrix Wⱼ(k), k represents the frequency bin number and j the transmitting antenna number.

The repeated pilot symbols may be preceded and/or followed by a cyclic prefix and may be transmitted on interleaved sub-carriers from the plurality of transmit antennas.

Alternatively, the independent pilot symbols, may each be preceded and/or followed by a cyclic prefix, and may be transmitted on interleaved sub-carriers from the plurality of transmit antennas.

In another alternative, each pilot symbol may be preceded and/or followed by a cyclic prefix that is transmitted on interleaved sub-carriers from the plurality of transmit antennas.

Preferably, a cyclic prefix window length or delay spread approximation length is chosen to enable the real and imaginary parts of the fixed weighting matrix to contain equal or zero entries. The length of the cyclic prefix window or the delay spread approximation can be (1+N/2) or (1+N/4) where N is the length of the Inverse Discrete Fourier Transform used to form the pilot symbol.

In a preferred arrangement the step of forming a sparse smoothing matrix includes:

calculating a plurality of possible sparse smoothing matrices;

storing the plurality of matrices in a storage device; and

selectively retrieving one of the plurality of possible sparse smoothing matrices from the storage device.

The storage device may conveniently be a look-up table.

The smoothing matrix may be selected for retrieval from the storage device according to characteristics derived from the least squares estimation matrix.

The characteristics may include any one or more of the signal to noise ratio SNR, the root mean square delay spread of the power delay profile τᵣₘₛ and the delay spread of the power delay profile τₓ.

The method may further include the step of:

making coefficients of the fixed weighting matrix real by performing a cyclic shift to locate the channel impulse response symmetrically around zero.

Conveniently, cyclic shift may be performed in either the time domain or by an equivalent linear phase rotation in the frequency domain.

The method may further include the step of:

using a symmetrically shaped delay spread approximation for the channel estimation. The delay spread approximation may be rectangular-shaped.

Another aspect of the invention provides a channel estimator for use in an orthogonal frequency-division multiplexing system, the channel estimator including:

a least-squares estimation unit for forming a least-squares estimation matrix from pilot symbols transmitted from a plurality of transit antennas;

a matrix formation unit for forming a sparse smoothing matrix approximating a fixed weighting matrix, wherein each row vector in the sparse smoothing matrix contains one or more of the strongest weights in each row of the fixed weighting matrix; and

a channel estimation unit for forming a channel estimation matrix from the sparse smoothing matrix and the least-squares estimation matrix.

Conveniently, the matrix formation unit may include:

a storage device for storing a plurality of possible sparse smoothing matrices; and

a matrix selection unit for selectively retrieving one of the plurality of possible sparse smoothing matrices from the storage device.

The storage device may be a look-up table.

The matrix formation unit may act to select the sparse smoothing matrices for retrieval from the storage device according to characteristics derived from the least squares estimation matrix.

In order to assist in arriving at an understanding of the present invention, a preferred embodiment is illustrated in the attached drawings. However, it should be understood that the following description is illustrative only and should not be taken in any way as a restriction on the generality of the invention as described here above.

In the drawings:

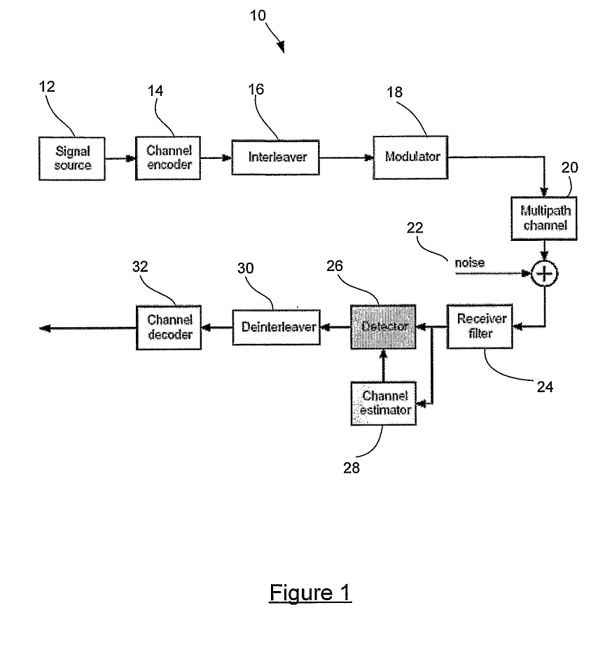

FIG. 1 is schematic diagram of an OFDM system;

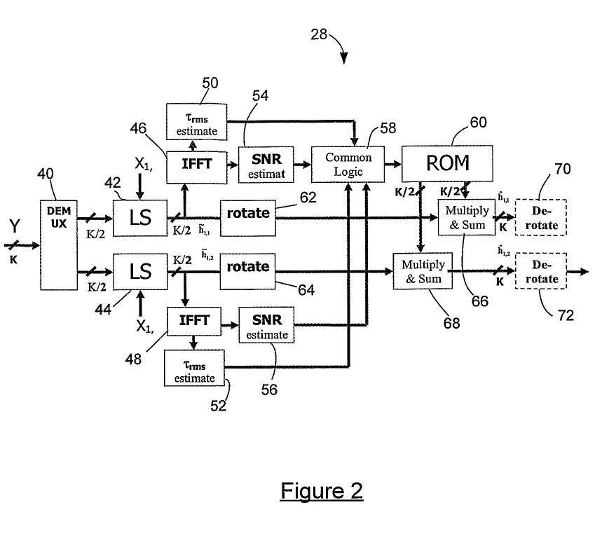

FIG. 2 is a schematic diagram of a channel estimator forming part of a receiver in the OFDM system of FIG. 1;

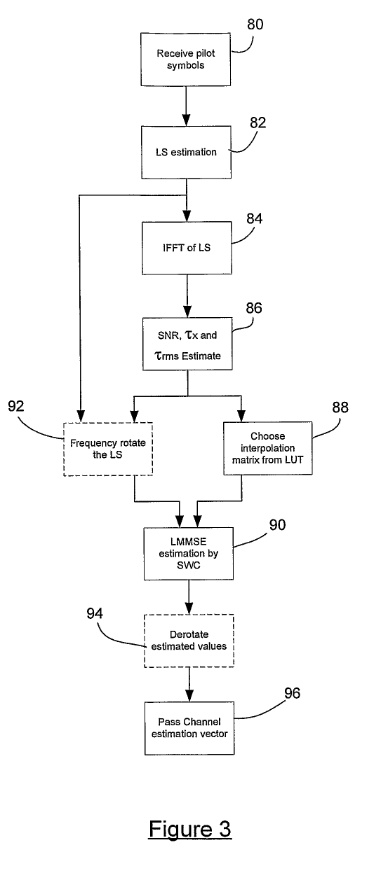

FIG. 3 is a flow chart illustrating operation of the channel estimation of FIG. 2;

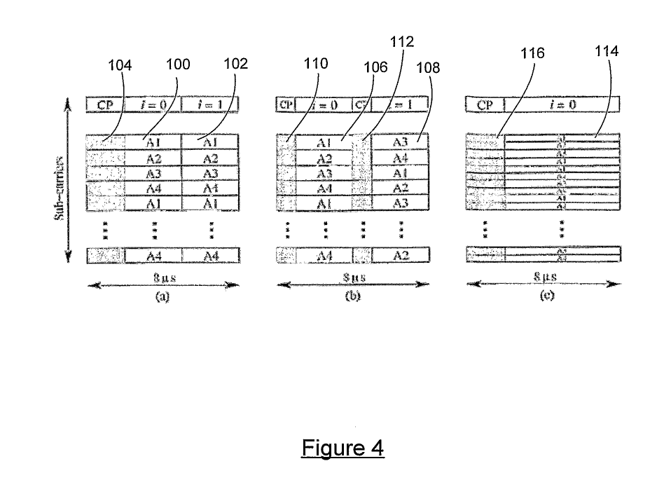

FIG. 4 is a diagrammatic representation of three different pilot symbol allocation schemes for use in the channel estimation process shown in FIG. 3;

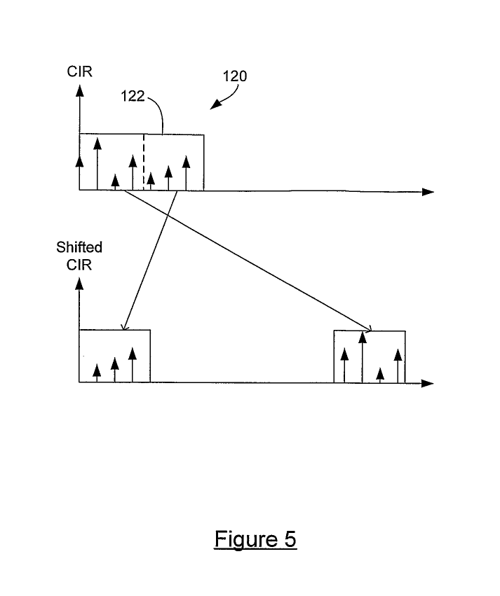

FIG. 5 is a diagrammatic representation of the symmetrical location around zero of the channel impulse response and uniform delay spread approximation used in the LMMSE channel estimation shown in FIG. 3;

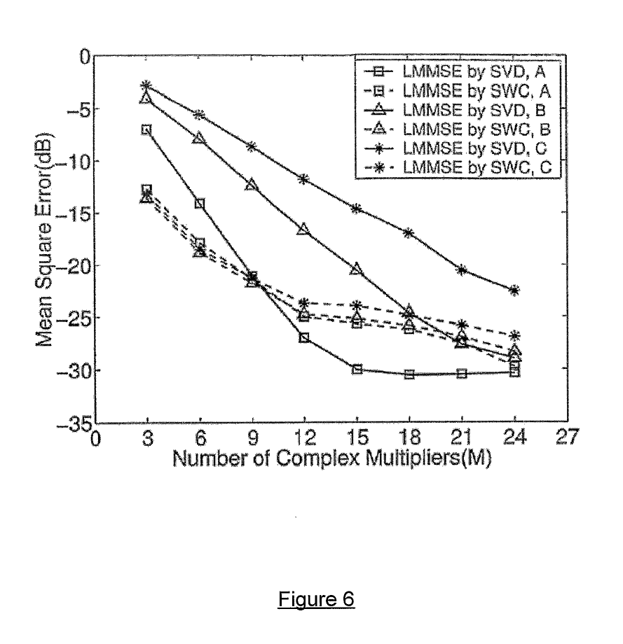

FIG. 6 shows the mean squared error performance vs complexity of the SWC method compared to the SVD method; and

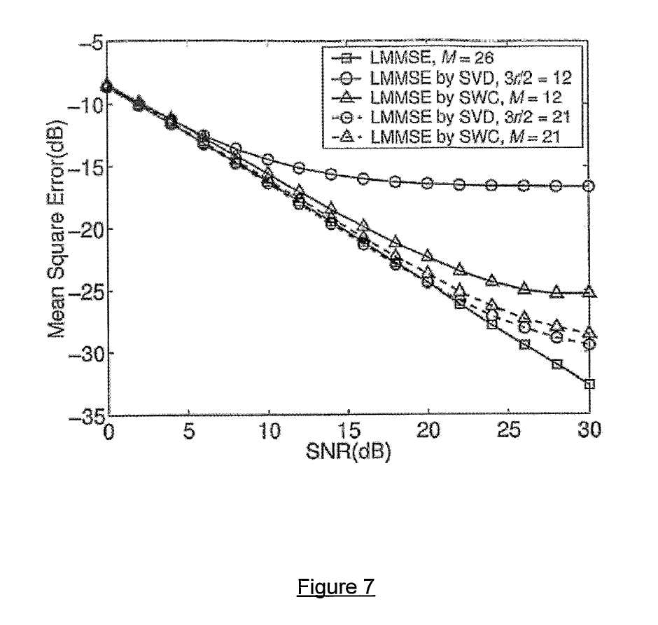

FIG. 7 shows the mean squared error performance vs SNR for the SVD and SWC schemes.

Referring now to FIG. 1, there is shown generally an OFDM based system 10 which exploits channel estimation and signal detection operations in equalisation. A digital signal source 12 is protected by channel coding from a channel encoder 14 and is interleaved by an interleaver 16 against fading phenomenon. After this, the binary signal is modulated by an OFDM modulator 18 and transmitted over a multipath fading channel 20. During transmission, noise 22 is added.

The sum signal is received at a receiver filter 24, which can take the form of a DFT (Discrete Fourier Transform), and the output of the filter then passed to a signal detector 26. Due to the multipath channel transmission, some inter-symbol interference occurs in the received signal. Accordingly, the signal detector 26 requires knowledge of the Channel Impulse Response (CIR) characteristics in order to ensure successful removal of the inter-symbol interference. The channel impulse response characteristics are determined by a channel estimator 28. After detection, the signal is de-interleaved by a de-interleaver 30 and the channel decoded by a channel decoder 32 to extract the original message.

Transmitter diversity is achieved in the OFDM system 10 shown in FIG. 1 by the use of multiple transmit antennas. To enable channel estimation, pilot symbols are simultaneously sent from the multiple transmitter antennas on interleaved sub-carriers. At the receiver end, the LMMSE channel estimator 28 identifies channel characteristics in the non-measured sub channels by interpolating different sets of measured sub channels from each specified antenna.

In a downlink diversity environment with two transmit antennas and one receiver, the two transmit antennas j=1, 2 simultaneously send to OFDM pilot symbols on K interleaved sub-carriers. The pilot symbols X, and X₂ are defined as follows:
x1={a₀, 0, a₁, 0, a₂, . . . , a_{K/2-1}, 0}
x2={0, b₀, 0, b₁, 0, b₂, . . . , 0, b_{K/2-1}} (1)
where aₖ and bₖ are arbitrary complex numbers with magnitude of 1.

Each of these signal forms an OFDM block. With the channel impulse response confined to a cyclic prefix (CP) length, the Digital Fourier Transform (DFT) of the received symbols can be given by

$$y ( k ) = {\sum }_{j = 1}^{2} {H}_{j} ( k ) {x}_{j} ( k ) + v ( k ) \qquad ( 2 )$$

where k=0, 1, . . . , K−1 denotes the sub-carrier number, Hⱼ(k) is the channel frequency response corresponding to transmit antenna j and v(k) is the additive complex Gaussian noise with zero mean and variance one.

In this exemplary embodiment, the channel estimator 28 is a packet-type channel estimator, where only the frequency correlation of the channel is used in the channel estimation. The frequency domain correlation depends on the multipath channel delay spread and can be described by a frequency domain correlation function rf(k). For an exponentially decaying multipath power delay profile, the frequency domain correlation function rf(k) can be given by

$$r f ( k ) = \frac{1}{1 + j2 {πτ}_{rms} k ( Δ f )} \qquad ( 3 )$$

where τᵣₘₛ is the root-mean square (rms) delay spread of the power delay profile and Δf denotes the sub-carrier spacing.

The LMMSE channel estimation vector Ĥⱼ corresponding to the jth transmitter in a 2×1 diversity system can be obtained as follows:
Ĥⱼ=R_{H}_{ⱼ}_{\tilde{P}}_{ⱼ}R_{\tilde{P}}_{ⱼ}_{\tilde{P}}_{ⱼ}⁻¹\tilde{P}ⱼ (4)
where

$${R}_{{H}_{j} {\tilde{P}}_{j}} = {R}_{{H}_{j} {P}_{j}} and {R}_{{\tilde{P}}_{j} {\tilde{P}}_{j}} = ( {R}_{{P}_{j} {P}_{j}} + \frac{1}{SNR} I )$$

are the correlation matrices of size K×K/2 and K/2×K/2 respectively [3]. I is the identity matrix and SNR is the expected value of SNR. \tilde{P}ⱼ is the least-squares (LS) estimation vector of length K/2 at the pilot positions corresponding to antenna j, given by
\tilde{P}ⱼ=Xⱼ⁻¹yⱼ (5)
where Xⱼ is a diagonal matrix containing the transmitted pilot points xj(k) given by (1).

The best low-rank approximation of R_{H}_{ⱼ}_{P}_{ⱼ}R_{\tilde{P}}_{ⱼ}_{\tilde{P}}_{ⱼ}⁻¹R_{\tilde{P}}_{ⱼ}_{\tilde{P}}^{1/2} is given by Singular Value Decomposition (SVD). Then, with the appropriate substitutions in (4), the rank-r estimator is defined by

$${\hat{H}}_{j} = {⋃}_{j} [ \begin{matrix}{\sum }_{j}^{r} & 0 \\ 0 & 0\end{matrix} ] {V}_{j}^{H} {R}_{{\tilde{P}}_{j} {\tilde{P}}_{j}}^{- 1 / 2} {\tilde{P}}_{j} \qquad ( 6 )$$

where ∪ⱼ and Vⱼ^{H} are unitary matrices, and

$${\sum }_{j}^{r}$$

is the r×r upper left corner diagonal matrix, containing the strongest singular values. The superscripts (.)^{r} and (.)^{H} denote rank-r and Hermitian transpose respectively.

In channels with large delay spreads, the rank-r approaches a value of K/3, the low rank approximation no longer reduces the estimator complexity.

The channel estimator 28 provides an alternative sparse approximation of the fixed weighting matrix, namely LMMSE by significant weight catching (SWC). For notional convenience, the equation (4) can be rewritten.
Ĥⱼ=Wⱼ\tilde{P}ⱼ (7)
where Wⱼ=R_{H}_{ⱼ}_{\tilde{P}}_{ⱼ}R_{\tilde{P}}_{ⱼ}_{\tilde{P}}⁻¹ is the fixed weighting matrix (otherwise known as the interpolation matrix).

Some row entries of the Wⱼ contain stronger weights than the others, with the strongest values on its diagonal.

The channel estimator 28 acts to restrict the frequency domain of the fixed weighting matrix Wⱼ to be a sparse (i.e only including limited number of non-zone elements) smoothing matrix containing the M strongest weights in each row, where M≦K/2. The sparse smoothing matrix approximating the fixed weighting matrix is obtained from:

$${E}_{j} ( k ) = {arg max}_{{w}_{j} ( k , m )} \{ ( {\sum }_{m = 0}^{M - 1} {\vert {w}_{j} ( k , m ) \vert}^{2} ) \vert {w}_{j} ( k ) \} \qquad ( 8 )$$

where wⱼ(k) denotes a row vector from the fixed weighting matrix.

FIG. 2 shows a practical implementation of the channel estimator 28. A de-multiplexer block 40 acts de-interleave pilot symbols into streams based on the transmit antenna from which the pilot symbols originated. Least squared estimators 42 and 44 are based on known pilot data and receive the pilot symbol streams from the de-multiplexer block 40. Inverse Fast Fourier Transform (IFFT) blocks 46 and 48 act to estimate the impulse response from which the route mean square delay spread (in blocks 50 and 52) and signal-to-noise ratio estimates (in blocks 54 and 56), together with other features, for example the absolute delay spread, are extracted. A common logic block 48 receives the signal-to-noise ratio estimates and route mean squared delay spread estimates and other features, and acts to select an appropriate sparse smoothing matrix from a lookup table stored in the non-volatile memory device 60. Rotators 62 and 64 act to rotate the least squared estimates generated by blocks 42 and 44, which are then multiplied and summed with the sparse smoothing matrix identified by the common logic block 58, by means of the multiply and sum blocks 66 and 68. The rotator block 62 and 64 perform a channel impulse response rotation in the frequency domain. The multiply and sum blocks 66 and 68 act to smooth and interpolate the least squared estimates exploiting the significant weight catching technique of the present invention. The rotating blocks 70 and 72 then act to de-rotate the output of the multiply and sum blocks 66 and 68 in order to generate the channel estimates. It should be noted that the de-rotation blocks 70 and 72 can be avoided if the data is pre-rotated.

The steps carried out by the channel estimator are depicted in FIG. 3. This figure shows that initially, at step 80, transmitted pilot symbols are received from the multiple transmit antennas used in the OFDM system with transmitted diversity shown in FIG. 1. At step 82, the least squares estimation matrix \tilde{P}ⱼ is computed by the channel estimator 28 according to the expression \tilde{P}ⱼ=Xⱼ⁻¹yⱼ.

The LMMSE channel estimation effector Ĥⱼ can be obtained from the product of a sparse smoothing matrix and the least squares estimation. In order to further minimise channel estimator complexity and improve the estimation accuracy of the channel estimator 28, a number of possible sparse smoothing matrices may be calculated and stored in a lookup table within the channel estimator 28 beforehand.

In order for this to occur, a channel impulse response is initially obtained by performing an Inverse Fast Fourier Transform (IFFT) operation at step 84 on the least squares estimation matrix. From the Inverse Fast Fourier Transform, the signal to noise ratio, the mean square delay spread of the power delay profile and delay spread of the received pilot symbols are firstly calculated. The power delay profile is the output of the IFFT and it is confined to the length of the cyclic prefix. A noise estimate can be taken from the other outputs to form an SNR estimate. The time between the first and last significant multipath component of the power delay profile is the delay spread and the rms delay spread can be obtained from:

$${σ}_{τ} = \sqrt{\frac{{\sum }_{i} {α}_{i}^{2} {τ}_{i}^{2}}{{\sum }_{i} {α}_{i}^{2}} - {( \frac{{\sum }_{i} {α}_{i}^{2} {τ}_{i}}{{\sum }_{i} {α}_{i}^{2}} )}^{2}}$$

where the αᵢ is the amplitude and τᵢ is the delay of the i'th multipath component.

With the knowledge of the aforementioned channel impulse response characteristics having been estimated at step 86, the most appropriate interpolation or sparse smoothing matrices is then selected by the channel estimator 28 from a lookup table, at step 88.

At step 90, the LMMSE channel estimation is carried out by computing the product of the sparse smoothing matrix selected by the channel estimator at step 58 and the least squares estimation matrix as determined in step 82. Broadband Wireless Local Area Networks (WLANs) incorporate two long OFDM pilot symbols at the beginning of a data packet, to enable channel estimation. The pilot symbols are preceded by a double length Cyclic Prefix (CP) to effectively eliminate inter-symbol interference and inter-carrier interference due to a fading channel. The following modified pilot schemes that enable the inclusion of transmitter diversity or multiple input multiple output systems within existing OFDM standards have been found to be particularly suitable for use with the present invention. The first scheme, shown in FIG. 4(a) consists of a standard pilot system in which two repeated (in this case long) pilot symbols 190 and 102 are preceded with a cyclic prefix 104. In this case, the cyclic prefix is a double length cyclic prefix of 1600 ns.

The second scheme, shown in FIG. 4(b) splits the two repeated pilot symbols into two independent pilot symbols 106 and 108, each of which is preceded with a cyclic prefix, in this case a single cyclic prefix of length 800 ns. The cyclic prefix preceding the pilot symbol 106 is referenced 110 in FIG. 4, whilst the cyclic prefix preceding the pilot symbol 108 is referenced 112.

The third scheme shown in FIG. 4(c) transmits a single pilot symbol 114 preceded by a cyclic prefix, in this case a double length cyclic prefix length of 1600 ns referenced 116 over twice the number of sub channels but half the bandwidth of the two previously mentioned schemes.

The three exemplary schemes shown in FIG. 4 are 4×1 antenna diversity system. The first two schemes form two consecutive OFDM pilot symbols xⱼ(i), i=(0, 1) for each antenna j=(1, 2, . . . , 4). The third scheme forms only one pilot symbol xⱼ(i), i=0 for each antenna j. All three schemes have a preamble length of 8 μs.

In channels with a limited mobility, the least squares estimation matrix \tilde{P}ⱼ of the two repetitive OFDM symbols in the first pilot scheme, shown in FIG. 4(a) can be obtained in step 82 as follows:

$${\tilde{P}}_{j} = \frac{1}{2} {X}_{j}^{- 1} {\sum }_{i = 0}^{1} {y}_{j} ( i ) , \qquad ( 9 )$$

where Xⱼ=Xⱼ(i), i=(0,1) is a diagonal matrix of size K/Q×K/Q containing the transmitted pilot points xⱼ(k).

The least \tilde{P}ⱼ squares estimation matrix in the second pilot scheme, shown in FIG. 4(b), can be obtained in step 62 by:
\tilde{P}ⱼ= P̅ⱼ(0)∪ P̅ⱼ(1) (10)
where \tilde{P}ⱼ(i) is the LS estimates vector of length K/Q, corresponding to the ith received pilot OFDM symbol from transmitter j, given by:
\tilde{P}ⱼ(i)=Xⱼ⁻¹(i)yⱼ(i) (11)

Equation (11) also represents the LS estimation vector \tilde{P}ⱼ= P̅ⱼ(i), i=0 of length 2K/Q for the third pilot scheme shown in FIG. 4(c). With 2K sub-carriers, this scheme requires a twofold increase for the correlation matrix size and FFT lengths, when calculating Ĥⱼ and yⱼ(i) respectively.

Channel estimator complexity can be further reduced (where the exponential power delay profile of the channel can be approximated as uniform), if the length of the uniform power delay profile is chosen correctly reduced complexity weighting coefficients result. The length of the power delay profile is usually set to the cyclic prefix length. “Good” Cyclic Prefix (CP) length windows are (1+N/2) or (1+N/4), where N is the length of the IDFT used to form the OFDM symbol. In this way the real and imaginary parts of the fixed weighting matrix values are made to contain equal or zero entries when “good” cyclic prefix length windows are chosen.

With a uniform power delay profile, coefficients of the fixed weighting matrix can be made real if the Channel Impulse Response (CIR) is located symmetrically around zero by performing a cyclic shift, as shown in FIG. 5. This approach makes all the coefficients of the fixed weighting matrix real, thus reducing the complexity of the computations required to be performed by the channel estimator 28.

FIG. 5 (top) shows a typical channel impulse response 120. A uniform (rectangular) shaped power delay profile 122 is drawn encompassing the impulse response. FIG. 5 (bottom) shows both the channel impulse response and the assumed uniform power delay profile shifted to the left and therefore centering this power delay profile about zero. This is achieved by a cyclic shift when used with DFT/IDFT block processing, as used by OFDM systems. The negative time components appear at the end of the block as shown in FIG. 5 (bottom).

Returning once again to FIG. 3, the sequence of steps carried out by the channel estimator 28 in order to provide the LMMSE channel estimation by significant weight catching may optionally include the steps of performing, at step 92, a phase rotation of the least squares estimation matrix derived in step 82, and a complimentary step 94 of performing a de-rotation of the LMMSE channel estimates derived in step 90. Finally, the channel estimation vectors are provided to the detector 26 in step 96.

The cyclic shift for the channel impulse response can be achieved in the frequency domain by applying a linear phase rotation across the LS frequency estimates of (−2πkp/N), where the shift, p, is half the length of the uniform power delay profile. Note p is negative for the complementary step of 94. The latter step can be avoided if the data symbols are pre-rotated.

If the “good” cyclic prefix windows are used, steps 92 and 94 may not be required. However, this approach can reduce the results provided by the channel estimator 28 due to a less than optimal windowing of the channel impulse response.

The Applicants have carried out simulations in an 802.11a system with 2 transmitters and 1 receiver. The mean squared error (MSE) for antenna j is given by:

$${MSE}_{j} = \frac{1}{K} trace ( E \{ ( {\hat{H}}_{j} - {H}_{j} ) {( {\hat{H}}_{j} - {H}_{j} )}^{H} \} ) \qquad ( 12 )$$

The system operated in an indoor HIPERLAN/2 non-sample-spaced channels A (τᵣₘₛ=50 ns), B (τᵣₘₛ=100 ns) and C (τᵣₘₛ=150 ns), with the total transmit power normalized to unity. It was assumed that perfect knowledge of the SNR and τᵣₘₛ were available for calculation of the Wⱼ.

The MSE channel estimation performance was evaluated by transmitting two long OFDM-BPSK pilot symbols through a fading multipath channel 1000 times. For each iteration, the pilot symbols were simultaneously sent from the two transmit antennas on interleaved sub-carriers. The duration of the two long pilots was 8 μs including double length CP of 1.6 μs and the total system bandwidth was subdivided into K=52 sub-carriers (out of a possible 64). For the sparse approximations, the number of complex multipliers (M<K/2) was chosen to give targeted MSE error floor ≦−25 dB.

It was observed that the LMMSE by Single Value Decomposition (SVD) outperforms the LMMSE by Significant Weight Catching (SWC) in channel A, when the rank r≦8 as can be seen in FIG. 6. At a fixed value of SNR=25 dB, its MSE error floor is well below of 25 dB and the estimator requires 12 complex multipliers. However, if the channel's delay spread is increased (channels B and C), the LMMSE by SWC is a better compromise in performance versus complexity, as shown in FIG. 6.

The LMMSE by SWC requires only 12 complex multipliers in order to reach an adequate performance in channel B and the estimator complexity is reduced by more than 50% compared to the full LMMSE. It should also be noted that the performance of the simplified LMMSE algorithm remains almost unchanged in all the channels, especially for the low number of complex multipliers (≦12). To illustrate the performance for a dynamic SNR range, the MSE in channel B is presented in FIG. 7. The number of complex multipliers M=3r/2 in the sparse approximations was set to the fixed nominal values of 12 and 21. With the MSE gain of 9 dB over the LMMSE by SVD for M=12 at SNR=30 dB, it can be seen that the LMMSE by SWC is the better choice for a reduced complexity LMMSE channel estimator.

From the foregoing, it is apparent that LMMSE by SWC estimation technique described above can reduce computational complexity of the traditional LMMSE channel estimator by more than 50% and it outperforms the LMMSE by SVD when channel delay spreads exceeding 50 ns.

Finally, it is to be understood that various modifications and/or additions may be made to the above described method of channel estimation without departing from the ambit of the present invention as defined in the claims appended hereto.

1. A method for performing channel estimation in an orthogonal frequency-division multiplexing system, the method including the steps of:
receiving transmitted pilot symbols from a plurality of transmit antennas;
forming a least-squares estimation matrix from the transmitted pilot symbols;
forming a sparse smoothing matrix approximating a fixed weighting matrix, wherein each row vector in the sparse smoothing matrix contains one or more of the strongest weights in each row of the fixed weighting matrix; and
deriving a channel estimation matrix from the sparse smoothing matrix and the least-squares estimation matrix.

2. A method according to claim 1, wherein the sparse smoothing matrix is defined according to:
$${E}_{j} ( k ) = {arg max}_{{w}_{j} ( k , m )} \{ ( {\sum }_{m = 0}^{M - 1} {\vert {w}_{j} ( k , m ) \vert}^{2} ) \vert {w}_{j} ( k ) \}$$
where Eⱼ(k) is the row of the sparse smoothing matrix with non-zero terms wⱼ(k,m) formed from the M strongest weights of the k'th row of the fixed weighting matrix Wⱼ(k); k represents the frequency bin number and j the transmitting antenna number.

3. A method according to claim 1, wherein repeated pilot symbols preceded and/or followed by a cyclic prefix are transmitted on interleaved sub-carriers from the plurality of transmit antennas.

4. A method according to claim 1, wherein independent pilot symbols, each preceded and/or followed by a cyclic prefix, are transmitted on interleaved sub-carriers from the plurality of transmit antennas.

5. A method according to claim 1, wherein a pilot symbol preceded and/or followed by a cyclic prefix is transmitted on interleaved sub-carriers from the plurality of transmit antennas.

6. A method according to claim 1, and further including the step of:
selecting a cyclic prefix window length or delay spread approximation length to enable real and imaginary parts of the fixed weighting matrix to contain equal or zero entries.

7. A method according to claim 6, wherein the length of the cyclic prefix window or the delay spread approximation is (1+N/2) or (1+N/4), where N is the length of the Inverse Discrete Fourier Transform used to form the pilot symbol.

8. A method according to claim 1, wherein the step of forming a sparse smoothing matrix includes:
calculating a plurality of possible sparse smoothing matrices;
storing the plurality of matrices in a storage device; and
selectively retrieving one of the plurality of possible sparse smoothing matrices from the storage device.

9. A method according to claim 8, wherein the storage device is a look-up table.

10. A method according to claim 8, wherein the smoothing matrix is selected for retrieval from the storage device according to characteristics derived from the least squares estimation matrix.

11. A method according to claim 10, wherein the characteristics include any one or more of the signal to noise ratio SNR, the root mean square delay spread of the power delay profile τᵣₘₛ and the delay spread of the power delay profile τₓ.

12. A method according to claim 1, and further including the step of:
making coefficients of the fixed weighting matrix real by performing a cyclic shift to locate the channel impulse response symmetrically around zero.

13. A method according to claim 12, wherein the cyclic shift is performed in either the time domain or by an equivalent linear phase rotation in the frequency domain.

14. A method according to claim 1, and further including the step of:
using a symmetrically shaped delay spread approximation for the channel estimation.

15. A method according to claim 14, wherein the delay spread approximation is rectangular-shaped.

16. A channel estimator for use in an orthogonal frequency-division multiplexing system, the channel estimator including:
a least-squares estimation unit for forming a least-squares estimation matrix from pilot symbols transmitted from a plurality of transit antennas;
a matrix formation unit for forming a sparse smoothing matrix approximating a fixed weighting matrix, wherein each row vector in the sparse smoothing matrix contains one or more of the strongest weights in each row of the fixed weighting matrix; and
a channel estimation unit for forming a channel estimation matrix from the sparse smoothing matrix and the least-squares estimation matrix.

17. A channel estimator according to claim 16, wherein the sparse smoothing matrix is defined according to:
$${E}_{j} ( k ) = {arg max}_{{w}_{j} ( k , m )} \{ ( {\sum }_{m = 0}^{M - 1} {\vert {w}_{j} ( k , m ) \vert}^{2} ) \vert {w}_{j} ( k ) \}$$
where Eⱼ(k) is the row of the sparse smoothing matrix with non-zero terms wⱼ(k,m) formed from the M strongest weights of the k'th row of the fixed weighting matrix Wⱼ(k); k represents the frequency bin number and j the transmitting antenna.

18. A channel estimator according to claim 16, wherein the matrix formation unit includes:
a storage device for storing a plurality of possible sparse smoothing matrices; and
a matrix selection unit for selectively retrieving one of the plurality of possible sparse smoothing matrices from the storage device.

19. A channel estimator according to claim 16, wherein the storage device is a look-up table.

20. A channel estimator according to claim 18, wherein the matrix formation unit acts to select the sparse smoothing matrices for retrieval from the storage device according to characteristics derived from the least squares estimation matrix.

21. A channel estimator according to claim 20, wherein the characteristics include any one or more of the signal to noise ratio SNR, the root mean square delay spread of the power delay profile τᵣₘₛ and the delay spread of the power delay profile τₓ.
